(19) United States
(12) Patent Application Publication
(10) Pub. No.: US 2020/0373532 A1
(43) Pub. Date: Nov. 26, 2020

(54) MODULE HOUSING, BATTERY MODULE, HIGH VOLTAGE BATTERY, MOTOR VEHICLE AND METHOD FOR INTRODUCING A HEAT TRANSFER MEDIUM BETWEEN A BATTERY MODULE AND A COOLING BOTTOM

(71) Applicant: AUDI AG, Ingolstadt (DE)

(72) Inventors: Marc GORMANNS, Erlenbach (DE); Tobias BENKER, Heilbronn (DE); MichaeI FRAUENHOFER, Aichach (DE); Pedro DE SOUSA SCHMIECH, Leingarten (DE); Michael SCHUESSLER, Neckarsulm (DE)

(73) Assignee: AUDI AG, Ingolstadt (DE)

(21) Appl. No.: 16/878,888

(22) Filed: May 20, 2020

(30) Foreign Application Priority Data
May 20, 2019 (DE) 10 2019 207 356.5

(51) Int. Cl. H01M 2/10; H01M 10/625; H01M 10/6567; H01M 10/6557; H01M 10/613

(52) U.S. Cl. CPC H01M 2/1077; H01M 10/625; H01M 2220/20; H01M 10/6557; H01M 10/613; H01M 10/6567

(57) ABSTRACT

The disclosure relates to a module housing for accommodating a cell stack having multiple individual battery cells for a high-voltage battery of a motor vehicle, wherein the module housing has at least one first side wall confining the cell stack in its longitudinal direction z when said cell stack is accommodated in the module housing. Herein, the at least one first side wall has a passage opening extending from a top to a bottom of the first side wall, in which a mixing element is arranged to mix a gap filler or, in general, a heat transfer medium and to convey the same underneath the battery module formed by the cell stack.

### FIELD

The disclosure relates to a module housing for accommodating a cell stack having a plurality of individual battery cells for a high-voltage battery of a motor vehicle, wherein the module housing has at least one first side wall confining the cell stack in its longitudinal direction when said cell stack is accommodated in the module housing. The invention also includes a battery module with such a module housing, a high-voltage battery for a motor vehicle, a motor vehicle and a method for introducing a heat transfer medium between a battery module and a cooling bottom.

### BACKGROUND

High-voltage batteries known from the prior art for motor vehicles usually have multiple battery modules, which in turn can have several individual battery cells. Such individual battery cells are typically arranged in a row in the form of a cell stack and accommodated in a module housing. The battery modules thus formed are inserted in a battery housing to form the high-voltage battery. Furthermore, such battery modules usually also need to be cooled. For this purpose, an appropriate cooling device may be designed integrally with the bottom of the battery housing, for example, or arranged below the housing bottom. Both cases result in providing a cooling bottom for the high-voltage battery. However, due to individual tolerances, arranging the battery modules in this overall battery module housing results in tolerances of varying sizes between the respective bottom sides of the battery modules and such a cooling bottom. In order to be able to dissipate the heat generated in the high-voltage batteries, especially during rapid charging and when power is drawn from the battery, a heat transfer medium, for example a thermal paste, also called a gap filler, is usually used between the battery modules and the cooling bottom. In this process, such a gap filler is first applied to the cooling bottom as a bead and then slowly spread across the area by positioning the battery module and lowering it.

This manner of introducing such a gap filler or generally a heat transfer medium between the battery module and the cooling bottom has numerous disadvantages. Among other factors, very high forces must be applied to the battery module to be able to distribute the gap filler with sufficient uniformity. At the same time, however, such forces must not lead to damage to the battery module, which in turn requires a robust design of the battery modules, driving up costs. In addition, due to the limited contact pressure, only relatively large gap heights between the battery module and the cooling bottom can be achieved with this method, which counteracts efficient heat dissipation, since the gap filler material conducts heat better than air, but nevertheless worse than metals. In addition, large gap heights increase the cost and weight of the high-voltage battery, as more gap filler mass is required.

In order to be able to build the future high-voltage batteries of electric vehicles cost-effectively and resource-efficiently, it is at least company-internal state-of-the-art to further develop a method by means of which a heat transfer medium such as gap filler can be injected between the battery module and the cooling bottom in a targeted manner. According to such a method, the battery module is first placed in the empty battery compartment, i.e., the battery housing, and is bolted in. The heat transfer medium is then injected into the gap remaining between the battery module and the cooling bottom due to tolerances. One option is to inject the heat transfer medium from below through a hole in the cooling bottom, as well as from above in the area of the battery module.

In the second variant, which is also the subject of the considerations in the context of the present invention, an injection head for injecting the heat transfer medium connects with the top of a tube integrated in the battery module, through which tube the heat transfer medium is injected and which guides the injection flow downwards, where the heat transfer medium is then squeezed between the module bottom and the cooling bottom. However, even with this type of introduction of a thermal conductive agent, problems still arise at present. On the one hand, a heat transfer medium such as the gap filler is typically composed of several components, which are mixed just prior to application, since these components begin to react when mixed and then cure after a certain time. Therefore, static mixers are used to introduce the heat transfer medium in the aforementioned tube, and the respective components are mixed while they pass through said mixers. The mixed components are then injected through the mixer directly into the tube. However, as the material starts to already react in the mixer, the mixer needs to be flushed regularly or needs to be replaced relatively often. Thus, it would be desirable to further simplify this process as well.

DE 10 2018 005 234 A1 describes a method for producing a battery having multiple battery cells for a motor vehicle, in which a thermal paste is applied to the battery cells, through which paste the battery cells are at least thermally coupled with a cooling device for cooling the battery cells, wherein a respective height of the respective battery cell is detected during the application of the thermal paste, and wherein the thermal paste is applied to the respective battery cell depending on the respective detected height. Thus, according to this method, each individual battery cell is provided with such a thermal paste. Due to its fundamental differences to the aforementioned methods, no solution to the aforementioned problems can be found using this method. Rather, this method, in which each individual battery cell has to be provided with thermal paste, only further complicates the manufacturing process of such a battery.

Furthermore, DE 196 46 683 A1 describes a device and a method for applying an electrode paste to a substrate for use in an electrolytic cell. Herein, the device comprises a mixing device, which mixes predefined amounts of an electrode paste and a polymerization initiator and then releases the mixture onto a substrate. The mixing device is designed to essentially preclude the polymerization of the electrode paste during this mixing process and also the polymerization before applying the mixture to the substrate. A static mixer is to be used as a means of precluding the polymerization. However, as described above, such a mixer ultimately is used to mix several components, whereby the onset of a reaction of these components cannot be avoided.

### SUMMARY

Therefore, the problem underlying the present invention is to provide a module housing, a battery module, a high-voltage battery, an motor vehicle and a method for introducing a heat transfer medium between a battery module and a cooling bottom, which method makes possible a very simple and gentle introduction of such a heat transfer medium between the battery module and the cooling bottom.

Therein, a module housing according to the invention for accommodating a cell stack having multiple individual battery cells for a high-voltage battery of a motor vehicle has at least one first side wall confining the cell stack in its longitudinal direction when said cell stack is accommodated in the module housing. Herein, the at least one first side wall has a passage opening extending from a top to a bottom of the first side wall, in which a mixing element is arranged.

Due to the fact that the mixing element is integrated into the passage opening, which can be provided in the tube in the battery module described above, the function of the static mixer described above can be advantageously integrated into this passage opening. No mixing is therefore necessary anymore at the actual injection head, which injects the components of the heat transfer medium and which can connect to this passage opening for injecting these components, such that this injection head no longer has to provide the functionalities of a static mixer and can therefore be designed in a much simpler manner. Consequently, rinsing processes or replacement processes to replace the static mixer or the injection head are no longer required. The injection head can then simply dock at the top of the injection tube, that is, at the passage opening, in order to convey the material, in particular the components to be mixed for providing the heat transfer medium, separately into the passage opening and the mixing element arranged therein. The mixing element itself can be manufactured as a fairly cost-effective element, for example as a plastic injection-molded component, and in any case remains on the battery module or within the passage opening of the module housing. As the mixing element therefore is only intended for single use, it does not need to be rinsed, cleaned or replaced. As the material costs for the gap filler are usually significantly higher than for such mixing elements made of plastic, additional costs can be saved by the invention, by achieving material reduction of the cost-intensive gap filler because rinsing processes are avoided. Also, a reduction in system availability due to such flushing times is no longer necessary, which means that the corresponding system for injecting gap filler can be used much more efficiently, which in turn can save costs. The same applies accordingly because a mixer replacement is not necessary anymore, which otherwise also costs time and thus reduces the system availability time. Furthermore, the injection method made possible by the module housing according to the invention and its further developments no longer has an accessibility problem during the mixer replacement, which usually must be taken into account, especially in the case of multiple injection processes. This makes the overall injection process much faster, simpler and more cost-effective. At the same time, the injection method described above makes it possible to fill or introduce the heat transfer medium between the battery module and the cooling bottom in a particular gentle manner.

The mixing element thus is preferably designed in such a way that, when multiple separate components to be mixed of a heat transfer medium are fed into the filling area of the passage opening, which areas faces the top, the components are mixed together while passing from the top to the bottom of the passage opening. The mixing element may be formed, for example, in a spiral shape, in particular also as a single spiral, double spiral or multiple spiral, for example with openings in the respective spirals. The now finally mixed gap filler, or generally, the mixed heat transfer medium, can accordingly escape from the bottom of the passage opening and thus spread out between the bottom of the battery module and the cooling bottom in a simple manner. It is particularly preferred when the mixing element is designed for mixing two components, in particular only two components. This can be easily achieved by a type of open coil. This is particularly advantageous, since most thermal pastes used as heat transfer media, in particular gap fillers, consist of two components. These can then be mixed particularly easily by means of a mixing element designed in this manner. However, the mixing element can also be designed to mix three or more components. This can also be achieved by means of an element with openings. The mixing element may be designed in the same manner, regardless whether two or three or possibly even more components are to be mixed.

The feeding of these multiple components to be mixed can also be performed by the injection head described above. Depending on the heat transfer medium to be used, the injection head can be designed for injecting two, three or more separated components to be mixed by means of the mixing element. These two or multiple components to be mixed are spatially separated from each other in the injection head itself, such that there is no contact between these two components in this injection head itself and accordingly no reaction between these components. For example, the two or more than two components can be filled into the filling area of the passage opening by means of a corresponding number of separated filling channels, which can be provided by this injection head. This means that regular rinsing, cleaning or replacing of the injection head is no longer necessary. This injection head can then, for example, approach several passage openings of one or multiple module housings sequentially and fill the corresponding components to be mixed into the respective passage openings without having to be replaced or cleaned in between. This means that significant time savings can be achieved in the gap filler injection process.

Furthermore, it is advantageous if the injection of the heat transfer medium or its individual components into the passage opening is performed under a certain filling pressure. Advantageously, this makes it possible that the components are pushed out of the bottom of the passage opening with a corresponding pressure and can thus spread out in a particularly simple and advantageous manner between the battery module and the cooling bottom, and thereby can fill the tolerance-related gap between the battery module and the cooling bottom.

As already described, the passage opening can be provided in a particularly simple manner as a cylindrical recess or as a tube. The mixing element can simply be inserted into this tube as a separately manufactured component. In other words, the mixing element does not necessarily have to be connected to this tube or the passage opening in a firmly bonded or interlocking manner. This also makes the design of the at least one first side wall with the pipe and the mixing element arranged therein particularly simple and cost-effective. As already mentioned, the mixing element preferably is made of plastic. Due to this, the mixing element can be produced in a particularly cost-effective manner and at the same time with a low weight. This benefits both the weight of the battery module, and also proves advantageous with regard to the single use of this mixing element.

In a further advantageous embodiment of the invention, the passage opening extends perpendicular to the longitudinal direction. Therein, the longitudinal direction of the cell stack, when it is accommodated in the module housing and in particular when the module housing is arranged on the cooling bottom, extends essentially parallel to the cooling bottom. In contrast, the passage opening should facilitate a filling of the heat transfer medium from the top of the battery module to the cooling bottom, which can be accomplished in a particularly efficient manner by an extension of the passage opening perpendicular to the longitudinal direction. However, it is also conceivable that the passage opening extends at a slight angle from the top of the battery module to its bottom, for example, and correspondingly from the top of the at least one first side wall to its bottom.

Furthermore, it is preferable if the module housing has two opposing first side walls and two second side walls extending in the longitudinal direction and connecting the first side walls to each other, wherein the first side walls are designed as end plates, between which the cell stack can be braced. The first side walls, in which the passage opening is arranged, thereby additionally assume a bracing function for bracing the cell stack. Such a passage opening with integrated mixing element does not necessarily have to be integrated in both of the first side walls, but may, for example, be included only by one of the two first side walls associated with a battery module. As the first side walls serve to brace the cell stack, they can accordingly be formed as compression plates, via which a certain pressure can be applied to the opposing ends of the cell stack by means of tension caused by the second side walls extending in the longitudinal direction. This counteracts the swelling of the battery cells, thereby extending the service life of the battery cells.

Furthermore, the module housing may be designed in such a way that no housing side covering the top or bottom of the cell stack is provided. In other words, both the first side walls forming or providing the end plates and the second side walls extending in the longitudinal direction represent sides of the module housing that are distinct from both a top and a bottom side. Both the first and the second side walls can be essentially aligned perpendicular to the top as well as to the bottom of the cell stack when it is accommodated in the module housing.

Furthermore, it also is possible to arrange multiple passage openings with integrated mixing elements, as described above, in a first side wall, which, however, does not necessarily have to be the case.

However, it is particularly advantageous if the passage opening is arranged in an edge area of the at least one first side wall with respect to a width of the at least one first side wall extending perpendicular to the longitudinal direction and perpendicular to the gradient direction of the passage opening. In other words, the passage opening is closer to the edge of this width of the first side wall than to the center of that width. This is particularly advantageous because it also means that additional components can be integrated in such a first side wall, which also acts as an end plate or pressure plate, such as electronic components, control devices such as module control units, or gripping elements, by which such a battery module can be easily gripped, moved and positioned, in particular by means of a so-called handling device, or other various components. By positioning this passage opening in the edge area, this passage opening does not interfere with other, additional components integrated in the at least one first side wall, nor with their function. In particular, integrating such a passage opening with integrated mixing element in the side area of the at least one first side wall does not require a design modification of this first side wall per se, nor of its other integrated components. This again makes it possible to provide such a sidewall, as well as the module housing and the battery module in general, particularly cost-effectively.

Furthermore, the invention also relates to a battery module with a module housing according to the invention or with one of its embodiments. In particular, such a battery module may also have a cell stack arranged in the module housing, such that a longitudinal direction of the cell stack, in which the individual battery cells of the cell stack are arranged side by side, is confined by the at least one first side wall.

The aforementioned advantages for the module housing according to the invention and its embodiments thus apply in the same way to the battery module according to the invention and its embodiments. Furthermore, the characteristics described in the context of the module housing according to the invention and its embodiments, and mentioned in the context of the cell stack which can be accommodated by the module housing, and the battery module thus formed, make possible the corresponding further development of the battery module according to the invention.

The individual battery cells can be designed as lithium-ion cells, for example, but also in any other way. The individual battery cells furthermore preferably are prismatic individual battery cells. These are arranged in the longitudinal direction preferably facing each other at their side with the largest expansion. A first side wall, which confines the cell stack in the longitudinal direction, is thus arranged adjacent to a first individual battery cell of the cell stack, and another first side wall, which confines the cell stack on the opposite side in its longitudinal direction, is arranged correspondingly adjacent to a last individual battery cell of the cell stack, while all other individual battery cells are arranged correspondingly between this first individual battery cell and this last individual battery cell in the longitudinal direction.

Furthermore, it is advantageous if the respective top sides of the individual battery cells, at which respective poles of the individual battery cells are arranged, define a top of the battery module. In other words, a battery module, in particular the battery module according to the invention or one of its embodiments, is arranged with its bottom on a cooling plate or a cooling bottom in such a manner that the respective poles positioned on the top of the individual battery cells face away from this cooling plate or this cooling bottom. In this manner, a particularly simple, effective and extensive cooling system can be provided at the bottom of the individual battery cells. The heat transfer medium for increasing the efficiency of heat dissipation from the bottom of the respective individual battery cells to such a cooling bottom can then be introduced accordingly, as already described above in detail, through the passage opening with integrated mixing element from the top of the battery module to the bottom of this battery module and accordingly between the battery module and the cooling bottom.

Furthermore, the invention also relates to a high-voltage battery for a motor vehicle, wherein the high-voltage battery has at least one battery module according to the invention or one of its embodiments, as well as a cooling bottom for cooling the at least one battery module, wherein the at least one battery module is arranged on the cooling bottom in such a manner that the passage opening extends from a side of the battery module facing away from the cooling bottom in the direction of the cooling bottom, and wherein a heat transfer medium, in particular the previously described heat transfer medium to be mixed from several components, such as a thermal paste, namely the so-called gap filler, is arranged between the bottom of the battery module facing the cooling bottom and the cooling bottom.

Again, the advantages described in the context of the module housing according to the invention and its embodiments also apply in the same manner to the high-voltage battery according to the invention. In addition, the high-voltage battery may also have several of the battery modules described above. Therein, an injection of the heat transfer medium into the respective passage openings provided by the several battery modules or their module housings can be performed simultaneously or sequentially.

Furthermore, the cooling bottom may be provided by a cooling plate, for example. Optionally, cooling channels, which allow a cooling medium or coolant to flow through them, can also be integrated into this cooling plate. Such a cooling plate with optionally integrated cooling channels may also be located on a bottom of the battery housing, in particular on a side facing away from the battery modules arranged in the battery housing, such that the bottom of the battery housing is located between a bottom of the battery modules and the cooling plate. Accordingly, the cooling bottom is provided by the combination of such a cooling plate with the housing bottom.

Furthermore, the invention also relates to a motor vehicle, in particular an electric and/or hybrid vehicle, with a high-voltage battery according to the invention or one of its embodiments.

The motor vehicle according to the invention is preferably designed as an automotive vehicle, in particular as a passenger car or heavy-goods vehicle, or as a passenger bus or motorcycle.

In addition, the invention includes a method for introducing a heat transfer medium between a battery module and a cooling bottom, wherein the battery module has a module housing and a cell stack having multiple individual battery cells, which is accommodated in the module housing, wherein the module housing has at least one first side wall, which confines the cell stack in its longitudinal direction. Therein, the battery module can be positioned at a defined distance from the cooling bottom, such that a bottom of the battery module faces toward the cooling bottom. Furthermore, the at least one first side wall has a passage opening extending from a top to the bottom of the first side wall, in which opening a mixing element is arranged, wherein multiple unmixed components of the heat transfer medium, which are to be mixed, are fed into a filling area of the passage opening, which area faces the top, escape from the bottom of the passage opening as components mixed into the heat transfer medium, and are squeezed between the battery module and the cooling bottom.

In particular, the mixed components escaping from the passage opening at its bottom end can be squeezed between the battery module and the cooling bottom due to the filling pressure with which the components are pressed into the filling area.

Again, the advantages described in the context of the module housing according to the invention and its embodiments also apply in the same manner to the method according to the invention.

The invention also includes further developments of the method according to the invention, which have characteristics as already described in the context of the further developments of the module housing according to the invention. For this reason, the corresponding further developments of the method according to the invention are not described here again.

The invention also includes the combinations of the characteristics of the embodiments described.

Exemplary embodiments of the invention are described in the following. The exemplary embodiments explained below are preferred embodiments of the invention. In the exemplary embodiments, the described components of the embodiments each represent individual characteristics of the invention to be considered individually, which characteristics each further develop the invention independently of each other. Therefore, the disclosure is intended to also comprise combinations of characteristics of the embodiments other than those shown. Furthermore, the described embodiments can also be complemented by further characteristics of the invention already described.

### BRIEF DESCRIPTION OF THE DRAWINGS

Exemplary embodiments of the disclosure are described in the following. The following is shown:

FIG. 1 The single drawing shows a schematic representation of a high-voltage battery with an exemplary battery module arranged in a battery housing, which battery module has a module housing according to an exemplary embodiment of the invention.

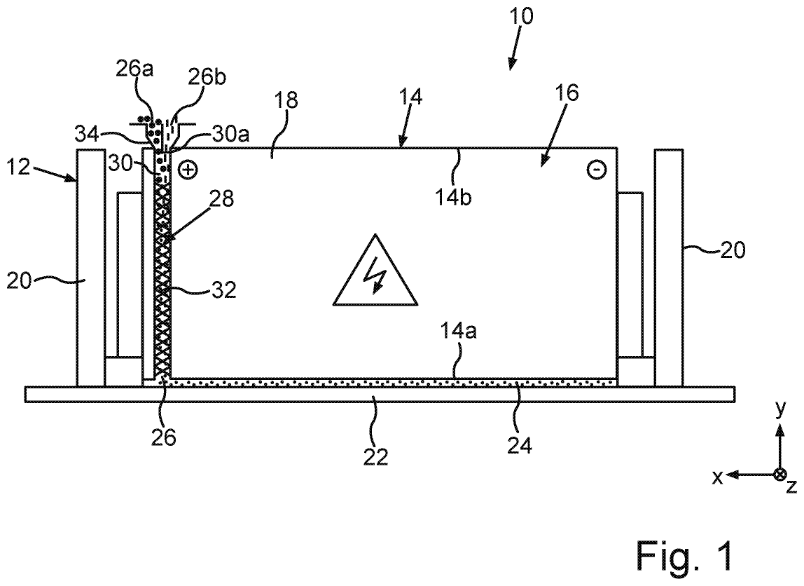

### DETAILED DESCRIPTION

The single drawing shows a schematic representation of a high-voltage battery 10 with an exemplary battery module 14 arranged in a battery housing 12, which battery module 14 has a module housing 16 according to an exemplary embodiment of the invention. In addition to the module housing 16, the battery module 14 has a cell stack with several individual battery cells, which is not explicitly shown here. This cell stack extends in a longitudinal direction that corresponds to the z-direction of the coordinate system shown here. This cell stack is confined in its longitudinal direction at its front and rear by respective first side walls 18, which in turn are connected to each other via two second side walls, which are also not explicitly shown here, and which also extend in the longitudinal direction z. In particular, the cell stack is braced between these first two side walls 18, which are connected to each other via these second side walls. A cell stack accommodated in such a module housing 16 then accordingly provides a battery module 14. In addition, multiple such battery modules 14 may be accommodated in the battery housing 12.

The battery housing 12 has a frame 20, to which the battery module 14 is attached, for example bolted, in particular attached with its module housing 16. In addition, the battery housing 12 also comprises a cooling bottom 22. This cooling bottom can be provided by a bottom and a separate cooling device arranged on it or by a cooling device, which also functions as the bottom of the battery housing 12. This cooling bottom 22 may in addition provide cooling channels which can allow a coolant to flow through them. By means of this cooling bottom 22, the battery modules 14, and in particular their individual battery cells, can be cooled, which is particularly relevant for example in the fast charging of the battery modules 14 as well as when power is drawn from them.

When the battery module 14 is bolted or fastened in the battery housing 12, a more or less large gap 24 always arises between the bottom 14a of the battery module 14 and the cooling bottom 22 due to tolerances. The bottom 14a of the battery module 14 also defines a bottom 14a of the first sidewall 18. The top 14b of the battery module 14, positioned opposite to this bottom 14a, also at the same time represents a top 14b of the first sidewall 18.

A heat transfer medium, such as a thermal paste, which is also called a gap filler, is usually introduced in this gap 24, since an air gap would provide thermal insulation and would severely impair the heat dissipation from the battery module 14 to the cooling bottom 22. Known methods for introducing such a heat transfer medium into such a gap, however, place a lot of strain on the battery module, in particular if the thermal paste is first applied to such a cooling bottom and then the battery module is placed on it and pressed in order to distribute the thermal paste as evenly as possible. This process only allows for realizing very large gap heights, which is detrimental to the heat dissipation. This also disadvantageously results in a heavy weight of such batteries as well as high costs due to the large amount of required gap filler. These disadvantages can now advantageously be eliminated or at least reduced in their extent by the invention and its embodiments as follows.

On the one hand, the invention, or its embodiments, for this purpose proposes an injection of such a heat transfer medium 26 from above, which is significantly gentler for the battery module 14 and in addition permits significantly thinner gap heights of the gap 24 between the bottom 14a of the battery module 14 and the cooling bottom 22, in particular gap heights in an order of magnitude of a maximum of one to two millimeters. In addition, a particularly efficient injection method can be implemented by means of the invention and its embodiments. Most gap fillers or, generally speaking, heat transfer media 26 consist of two or three components, which should be mixed only shortly before application, as these react with each other upon contact and then gradually cure. The drawing shows schematic representations of two such components 26a and 26b of such a thermal paste 26. A static mixer 28 is used to mix these components 26a, 26b. This is now advantageously integrated into the module housing 16. This is made possible by the fact that a passage opening 30 is arranged in the module housing 16 in the form of a tube from the top 14b of the side wall 18 to the bottom 14a, in particular in at least one of the first side walls 18, and that a mixing element 32 also is included in this passage opening 30. If, conversely, such a static mixer 28 were provided as a component separate from the battery module 14 or from the module housing 16, by means of which component the already mixed components 26a, 26b were to be injected into such a passage opening 30, the following disadvantages would arise: On the one hand, such a separate static mixer system would then have to be flushed regularly or also be replaced from time to time, since the mixed components 26a, 26b would then cure and thereby would eventually clog or close the static mixer. However, a large proportion of gap filler material is lost unused as a result of these rinsing processes. In addition, the rinsing and replacement processes require time, which in turn reduces system availability, and in addition, these static mixers must also be sufficiently accessible for replacement, which in turn causes logistical problems. Another major disadvantage, however, is that in such an approach the mixed heat transfer medium would have to travel a significantly longer distance to arrive at the gap 24, which results in additional tolerances and inaccuracies in the adjustment of the filling pressure or injection pressure. All these disadvantages can be avoided in an advantageous way by integrating the mixer 28 directly into the first side wall 18, by integrating the mixing element 32 directly in the passage opening 30, which can also be referred to as a tube, in particular injection tube or pouring tube. Thus, such a pouring tube 30 on the battery module 14 and the mixer 28 can be advantageously combined. If such a mixing element 32 is then immediately integrated into such an injection tube 30 on the battery module 14, the gap filler 26 is advantageously mixed there and at the same time arrives underneath the battery module 14, where it is intended to be. Thus, no mixing is necessary at the actual injection head, which is labeled here with the reference number 34 and which is not an integral part of the battery module 14, but which approaches the passage opening 30 to fill the components 26a, 26b into the filling area 30a of the passage opening 30, such that this injection head 34 can be embodied significantly simpler on the one hand, particularly without a mixing element since this is already integrated into the passage opening 30, and, furthermore, rinsing or replacement processes are no longer required with regard to this injection head 34, as it does not become clogged, as the individual components 26a, 26b of the heat transfer medium 26 pass through this injection head 34 spatially separated from each other.

The injection head 34 can thus simply dock at the top of the pipe 30 for injecting the components 26a, 26b of the thermal paste 26 and convey the material, that is, in this example, the two components 26a, 26b, into the mixer 28, which is integrated in the pipe 30. The mixing element 32 which is integrated in the tube 30, can furthermore be designed as a particularly cost-effective element, such as a plastic element, which can be manufactured in an injection molding process. Once manufactured, this element can be easily inserted into the pipe 30 as a separate component and remain there, even after filling the heat transfer medium 26 into the gap 24.

The great advantage of the invention and its embodiments is therefore that the mixing element 32 and injection tube 28, which would have to be provided as such anyway, can now be combined to form such a mixer 28 without needing to provide a separate mixer. This results in a previously described series of advantages, which significantly overcompensates for the minimally higher costs for the fixed integration of the mixing element 32 into the battery modules 14. These advantages result, as already described, on the one hand from the material savings of the significantly more expensive gap filler 26 by avoiding the rinsing processes, in particular due to exceeding the permissible exposure time, by increasing the system availability due to rinsing times, by the fact that a mixer replacement is no longer necessary, which in turn results in time savings and an increase in system availability, as well as by the fact that the accessibility problem during the mixer replacement, which must be taken into account above all in the case of multiple injections, is also completely eliminated.

Overall, the examples show how an integration of the mixing element into the injection tube of the battery module can be provided by the invention, which makes it possible to mix multiple components of a thermal paste directly in the injection tube, whereby the injection process can be made significantly simpler, faster and more cost-effective.

1. A module housing for accommodating a cell stack having multiple individual battery cells for a high-voltage battery of a motor vehicle, wherein the module housing has at least one first side wall confining the cell stack in its longitudinal direction when said cell stack is accommodated in the module housing, wherein the at least one first side wall has a passage opening extending from a top to a bottom of the first side wall, in which a mixing element is arranged.

2. The module housing according to claim 1, wherein the mixing element is designed in such a way that, when multiple components of a heat transfer medium, which are separate and are to be mixed, are fed into the filling area of the passage opening, which area faces the top, the components are mixed together while passing from the top to the bottom of the passage opening.

3. The module housing according to claim 1, wherein the passage opening extends perpendicular to the longitudinal direction.

4. The module housing according to claim 1, wherein the module housing has two opposing first side walls and two second side walls extending in the longitudinal direction and connecting the first side walls to each other, wherein the first side walls are designed as end plates, between which the cell stack can be braced.

5. The module housing according to claim 1, wherein the passage opening is arranged in an edge area of the at least one first side wall with respect to a width of the at least one first side wall extending perpendicular to the longitudinal direction, and perpendicular to the gradient direction of the passage opening.

6. A Battery module having a module housing according to claim 1 and having a cell stack arranged in the module housing, such that a longitudinal direction of the cell stack, in which the individual battery cells of the cell stack are arranged side by side, is confined by the at least one first side wall.

7. The Battery module according to claim 6, wherein respective top sides of the individual battery cells, at which respective poles of the individual battery cells are arranged, define a top of the battery module.

8. A High-voltage battery for a motor vehicle, wherein the high-voltage battery has at least one battery module according to claim 6, and a cooling bottom for cooling the at least one battery module, wherein the at least one battery module is arranged on the cooling bottom in such a manner that the passage opening extends from a side of the battery module facing away from the cooling bottom in the direction of the cooling bottom, and wherein a heat transfer medium is arranged between the bottom of the battery module facing the cooling bottom and the cooling bottom.

9. A method for introducing a heat transfer medium between a battery module and a cooling bottom, wherein the battery module has a module housing and a cell stack having multiple individual battery cells, which is accommodated in the module housing, wherein the module housing has at least one first side wall, which confines the cell stack in its longitudinal direction, wherein the at least one first side wall has a passage opening extending from a top to the bottom of the first side wall, in which opening a mixing element is arranged, wherein multiple unmixed components of the heat transfer medium, which are to be mixed, are fed into a filling area of the passage opening, which area faces the top, and exit the bottom of the passage opening as components mixed into the heat transfer medium, and are squeezed between the battery module and the cooling bottom.

10. The module housing according to claim 2, wherein the passage opening extends perpendicular to the longitudinal direction.

11. The module housing according to claim 2, wherein the module housing has two opposing first side walls and two second side walls extending in the longitudinal direction and connecting the first side walls to each other, wherein the first side walls are designed as end plates, between which the cell stack can be braced.

12. The module housing according to claim 3, wherein the module housing has two opposing first side walls and two second side walls extending in the longitudinal direction and connecting the first side walls to each other, wherein the first side walls are designed as end plates, between which the cell stack can be braced.

13. The module housing according to claim 2, wherein the passage opening is arranged in an edge area of the at least one first side wall with respect to a width of the at least one first side wall extending perpendicular to the longitudinal direction, and perpendicular to the gradient direction of the passage opening.

14. The module housing according to claim 3, wherein the passage opening is arranged in an edge area of the at least one first side wall with respect to a width of the at least one first side wall extending perpendicular to the longitudinal direction, and perpendicular to the gradient direction of the passage opening.

15. The module housing according to claim 4, wherein the passage opening is arranged in an edge area of the at least one first side wall with respect to a width of the at least one first side wall extending perpendicular to the longitudinal direction, and perpendicular to the gradient direction of the passage opening.

16. A High-voltage battery for a motor vehicle, wherein the high-voltage battery has at least one battery module according to claim 7, and a cooling bottom for cooling the at least one battery module, wherein the at least one battery module is arranged on the cooling bottom in such a manner that the passage opening extends from a side of the battery module facing away from the cooling bottom in the direction of the cooling bottom, and wherein a heat transfer medium is arranged between the bottom of the battery module facing the cooling bottom and the cooling bottom.
